(19) United States
(12) Patent Application Publication
(10) Pub. No.: US 2008/0080505 A1
(43) Pub. Date: Apr. 3, 2008

(54) Methods and Apparatus for Performing Packet Processing Operations in a Network

(76) Inventor: Robert J. Munoz, Round Rock, TX (US)

Correspondence Address: RYAN, MASON & LEWIS, LLP, 90 FOREST AVENUE, LOCUST VALLEY, NY, 11560, US

(21) Appl. No.: 11/536,858

(22) Filed: Sep. 29, 2006

(51) Int. Cl. H04L 12/56

(52) U.S. Cl. 370/392; 370/401

(57) ABSTRACT

A network device is operative to perform different network operations on a packet of data in a network. The packet of data has a packet payload comprising one or more encoded characters. A lookup table comprises a plurality of table entries. Packet processing circuitry coupled to the lookup table determines which of the different network operations to perform on the packet of data at least in part by addressing the lookup table with a table input. The table input comprises one or more characters from the packet payload. The table entry corresponding to the table input is determined by a longest prefix match algorithm.

### FIELD OF THE INVENTION

The present invention relates generally to network devices, and, more particularly, to packet processing operations in network devices.

### BACKGROUND OF THE INVENTION

Packets of data in a network (hereinafter just “packets”) typically comprise a header portion, a payload portion and a trailer portion. The header portion usually contains instruction about the data carried by the packet such as the length of the packet, packet number, protocol, destination address and originating address. In contrast, the payload portion often contains the actual data that the packet is delivering to a destination. Finally, the trailer portion typically contains a couple of bits that tell a receiving network device that it has reached the end of the packet.

Examining the content of a packet's payload allows a network device to perform, for example, filtering and other firewalling functions. One way to implement this functionality in a network device is to use the well known correspondence between regular expressions and finite state machines to construct deterministic finite automata (DFA) in the form of a finite state machine. The DFA scans the packet payload and outputs an indication of which regular expression, if any, was matched by the packet payload and which subsequent action to take on the packet. DFAs, as one skilled in the art will recognize, typically consist of a set of states and transition functions that maps each state to a next state.

DFAs for examining packet payloads are typically implemented in network devices that have access to conventional general-purpose processors and memories (e.g., random access memories). Nevertheless, many less-capable network devices, such as, for example, routers, bridges and switches, are typically not designed to have access to such general purpose processors and memories. These devices typically function by addressing one or more lookup tables through fixed-function hardware such as content-addressable memories (CAMs). Therefore, implementing packet payload based processing in such less-capable network devices, while desirable, may be problematic.

There is, as a result, a need for methods and apparatus for implementing packet payload processing in those network devices that do not have access to general purpose processors and memories.

### SUMMARY OF THE INVENTION

Embodiments of the present invention address the above-identified need by providing methods and apparatus that allow packet payload processing in network devices that do not have access to general purpose processors and memories.

In accordance with an aspect of the invention, a network device is operative to perform different network operations on a packet of data in a network. The packet of data has a packet payload comprising one or more encoded characters. A lookup table comprises a plurality of table entries. Packet processing circuitry coupled to the lookup table determines which of the different network operations to perform on the packet of data at least in part by addressing the lookup table with a table input. The table input comprises one or more characters from the packet payload. The table entry corresponding to the table input typically is determined by a longest prefix match algorithm.

In accordance with an illustrative embodiment of the invention, a network device comprises a router. The router may perform several different operations on a received packet in response to the content of that packet's payload, which contains one or more encoded characters. The router determines which operation to perform on the received packet by addressing a lookup table one or more times. When addressing the lookup table, the router uses a table input comprising a state value and one or more characters from the received packet's payload. The table entry in the lookup table corresponding to the table input is determined based on a longest-prefix match algorithm. The lookup table returns a new state value and, for certain table entries, an action to be performed by the router.

Advantageously, the above-described network device in the illustrative embodiment may be implemented without requiring that the device have access to a general purpose processor or memory.

These and other features and advantages of the present invention will become apparent from the following detailed description which is to be read in conjunction with the accompanying drawings.

### BRIEF DESCRIPTION OF THE DRAWINGS

FIG. 1 shows a block diagram of a network in which an illustrative embodiment of the invention is implemented.

FIG. 2 shows a block diagram illustrating a network device in accordance with an illustrative embodiment of the invention.

FIG. 3 shows the configuration of a lookup table in the FIG. 2 network device.

FIG. 4 shows a flow diagram of an illustrative process for performing network operation in the FIG. 2 device in accordance with aspects of the invention.

FIG. 5 shows an illustrative lookup table in accordance with a second illustrative embodiment of the invention.

FIG. 6 shows the content of an illustrative packet payload on which the FIG. 5 lookup table may act.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

The term “network device” as used herein may comprise any type of electronic device capable of performing network operations on packets in a network. Such network devices may include, but are not limited to, routers, gateways, bridges, switches, hubs and repeaters. These devices and their many variants will be familiar to one skilled in the art. Examples of such network devices are also described in, for example, P. Seifert, The Switch Book: The Complete Guide to LAN Switching Technology, Wiley, 2000, which is incorporated herein by reference.

In addition, the term “packet of data” or “packet” as used herein is intended to encompass any unit of data for transmission in a network. No limitations as to the size, content or format of the data is intended by the use of this terminology.

For simplicity in describing the present invention, the invention will be illustrated with an embodiment comprising a router acting in conjunction with a simple LAN. FIG. 1 shows a router 100 implemented to service a LAN 110. In this implementation, the router is the interface between the LAN and the larger internet 130. The LAN is shown to contain M computers, labeled 115-i, where i=1, 2 . . . M. The computers are connected to each other and to the router via conventional Ethernet cabling 117.

As is typical, a packet received by the router 100 will contain information populating various portions of the packet, namely, a header portion, a payload portion and a trailer portion. The header portion contains information populating various protocol header fields associated with the protocol stack for that particular packet. A packet in the internet, for example, will frequently comprise data populating protocol header fields corresponding to the HTTP, TCP, IP and Ethernet protocols. The payload portion, in turn, contains the actual data that the packet is delivering to its destination. The trailer portion of the packet contains a couple of bits that tell a receiving network device that it has reached the end of the packet. It should be noted that the packet need not be of this form. For example, it need not include a trailer portion.

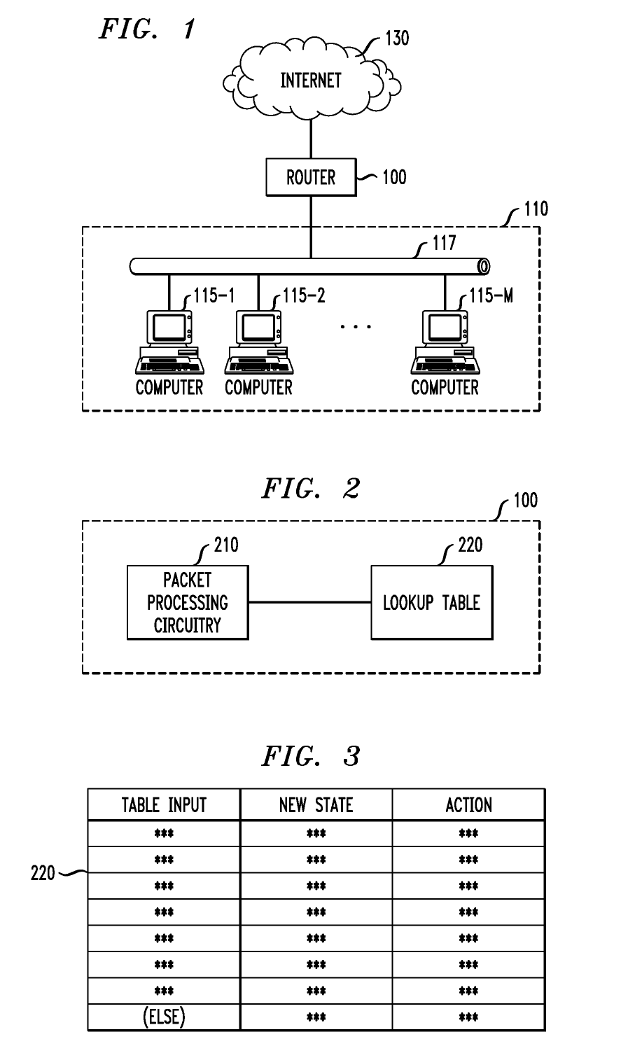

FIG. 2 shows a block of a further breakdown of the router 100. In accordance with aspects of the invention the router comprises two elements: packet processing circuitry 210 and a lookup table 220. FIG. 3, moreover, shows the configuration of the lookup table. The lookup table comprises a plurality of table entries. Each table entry associates a table input with a new state value and, in some cases, an action. The function of the elements within the router and the content of the lookup table will become apparent to one skilled in the art from the following discussion. Once understood, one skilled in the art will recognize how to configure packet processing circuitry and lookup tables in accordance with aspects of the invention to provide a desired functionality.

In accomplishing its functions, the router 100 will determine which network operation to perform on a received packet of data and then actually perform that network operation. In this particular example, the router is tasked with providing a filtering function (e.g., firewalling function) based on the content of a received packet's payload. Accordingly, the router will first examine the payload of received packet to determine if the packet of data should be discarded or forwarded on to its next destination. If the packet is to be forwarded onward, the router will examine relevant portions of the packet's header portion (e.g., information in the packet's protocol header fields) and forward the packet onward in a conventional manner.

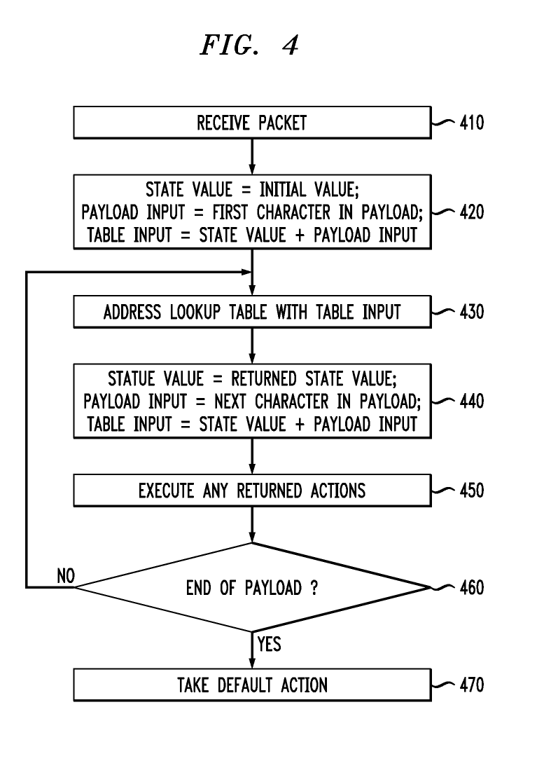

The examination of a received packet's payload by the router 100 will now be described with reference to FIG. 4. In performing its functions, the packet processing circuitry 210 will address the lookup table 220 with table inputs that comprise combinations of state values and payload inputs. State values are merely variables (e.g., integers) that indicate which state in the state machine (e.g. a deterministic finite automata) has been achieved up to that point in the examination. Payload inputs, on the other hand, are characters read from the packet payload itself or derived based on some transformation of character(s) read from the packet payload. A character in the payload may be a letter, number or symbol. One skilled in the art will recognize how such characters are encoded in a packet. A character may, for example, be encoded by an 8-bit binary ASCII code or by any one of several other character encoding formats (e.g., Uniform Transformation Formats −8 and −16). Alternatively a set of characters may be transformed into a token and the token may be used in place of the actual set of characters. Any one of these formats would still come within the scope of this invention.

Now referring to FIG. 4, step 410 comprises receiving a packet. The next step, step 420, comprises having the packet processing circuitry 210 of the router 100 set the state value to an initial value and set the payload input to the first character in the packet payload. The table input is then set to a string equal to a combination of the state value and the payload input. In the step 430, the packet processing circuitry addresses the lookup table with the table input. For example, if the state value is zero and the first character in the packet payload is “m,” the packet processing circuitry will address the lookup table with the string “0m.” The lookup table, in turn, finds the table entry corresponding to the provided table input and returns to the packet processing circuitry a new state value and, in some cases, an action.

In accordance with an aspect of the invention, the table entry corresponding to any table input is determined based on a longest-prefix match algorithm. One skilled in the art will recognize that, after receiving a table input, a longest-prefix match algorithm will select the table entry with the greatest number of characters that match, in correct order starting at the beginning, the provided table input when determining which table entry corresponds to the provided table input. Longest-prefix match algorithms are used extensively in conventional routing tables which typically match next-hop addresses to destination addresses. Frequently, one destination address for a received packet may match more than one routing table entry. The most specific entry (i.e., the entry where the largest number of leading address bits in the table entry matches those of the provided destination address) is selected as the longest-prefix match.

It will be noted that the lookup table 220 comprises a table entry with an input comprising the value “else.” This “else-entry” is a default table entry and is selected by the lookup table when there is no longest-prefix match between a table input and any one of the other table entries. The else-entry may be implemented by, for example, leaving the input portion of a table entry blank. The purpose of the else-entry will become apparent to one skilled in the art when a more concrete example of table lookups is described below.

As stated above, a table entry in the lookup table 220 returns a new state value and possibly an action. In step 440, the packet processing circuitry sets the state value to the new state value returned from the lookup table and sets the payload input to that the next character in the packet payload. Next, in step 450, the packet processing circuitry executes any returned action. Depending on the type of action, the action may end the examination of the packet payload or allow the examination to continue. Step 460 asks if the end of the packet payload has been reached. If the answer is no, the packet processing circuitry returns to step 430 and again addresses the lookup table with a table input equal to a combination of the current state value and payload input. Alternatively, if the end of the packet payload has been reached, the packet processing circuitry executes a predetermined default action. The default action may, for example, direct the router 100 simply forward the packet onward in a conventional manner. Alternatively, the current state can be stored and used as the starting state for examining the contents of the next packet that is part of the same session or flow.

Reference to FIG. 4, therefore, shows that a process in accordance with aspects of this invention for analyzing and responding to the content of a received packet's payload comprises repeatedly addressing a lookup table with different state values and payload inputs (i.e., characters encoded into the packet payload) until an action returned from the lookup table ends the analysis or the end of the packet payload is reached. The table entry corresponding to the state value and packet input is determined by a longest prefix match algorithm. If the end of the packet payload is reached, the process ends and a predetermined default action is executed.

It should be noted that it may be advantageous in some circumstances to have the packet processing circuitry 210 examine a received packet's header portion before beginning the examination of the packet's payload. The header portion of the received packet may indicate what type of information is contained within the packet's payload (e.g., whether the packet is a web request or part of an electronic mail message). This type information may be useful in determining whether or not to examine the packet's payload at all and in determining what particular type of examination should be conducted.

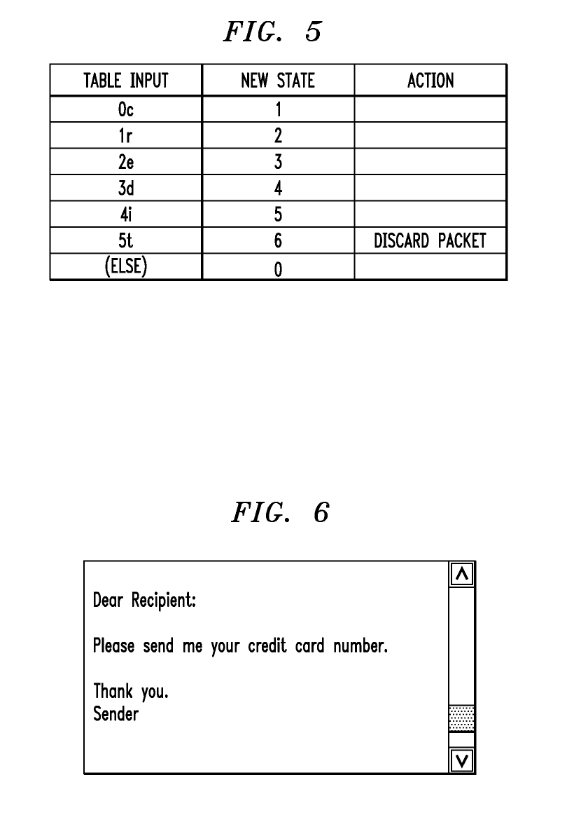

A more concrete example may be helpful in further describing the illustrative process flow described in FIG. 4. For this example, let it be assumed that the router 100 in FIGS. 1 and 2, in addition to being tasked with conventional packet forwarding operations, is further tasked with discarding received packets of data in response to various text expressions encoded into the received packets' payloads. More specifically, let it be assumed that the router is tasked with discarding packets that contain the text expression “credit” in the packet payload for the purpose of reducing digital communications (e.g., electronic mail) that may be directed to perpetrating credit card fraud. Let it further be assumed that, for this purpose, at least a portion of the router's lookup table 220 is configured as shown in FIG. 5.

Let it even further be assumed that the router 100 receives a packet containing the text shown in FIG. 6 encoded into its payload. After receiving the packet in step 410 of FIG. 4, the router's packet processing circuitry 210 sets a state value to an initial value, here, state value “0,” and also sets the payload input to the first character in the received packet, here, the letter “D,” in accordance with step 420. Next, in step 430, the packet processing circuitry addresses the lookup table 210 (now at least partially configured like the lookup table in FIG. 5) with a string comprising the current state value and payload input, namely, “0D.” The lookup table in turn finds a corresponding table entry based on a longest-prefix match algorithm. Here, there is no longest-prefix match table entry matching “0D” so the else-entry is selected. Accordingly, the lookup table returns a new state “0” to the packet processing circuitry.

Next, in step 440, the state value is set to the returned state value (i.e., “0”) and the payload input is set to the next character in the received packet (“e”). In step 460, the packet processing circuitry determines that the end of the packet payload has not been reached and returns to step 430, where it addresses the lookup table again, this time with the table input “0e.”

Continuing to follow the process set forth in FIG. 4, one skilled in the art will recognize that the packet processing circuitry 210 continues to maintain the “0” state value and choose the else-entry in the lookup table 220 until the payload input is set to the letter “c” in the word “Recipient.” When addressing the lookup table with the string “0c” at this point in the sequence, the lookup table returns the new state “1.” However, when the lookup table is subsequently addressed with the string “1i” (corresponding to the letter “i” following the “c” in the word “Recipient”), the else-entry is again the longest-prefix match in the lookup table. Accordingly, the state value is returned to “0.”

The state value is maintained at state value “0” until the payload input is set to “c” in the word “credit.” At this point, the lookup table 220 again returns a new state value of“1.” When, the lookup table is next addressed with “1r,” it returns a state value of “2.” This stepping up of the state value as the packet processing circuitry 210 steps through the letters in “credit” continues until the packet processing circuitry finally addresses the lookup table with the string “5t.” At this point in the process, the lookup table returns an action in addition to a new state value. As shown in the lookup table in FIG. 5, the action directs the router to discard the packet. The router executes this action in step 450, ending the need for further analysis of the packet.

It should be noted that if the received packet had not contained the word “credit,” the above described sequence would have progressed until the packet processing circuitry 210 reached the end of the packet's payload. At this point, the router 100 would have executed a default action in accordance with step 480, for example, forwarding the packet in a conventional manner.

While the previous example was limited to the detection of a single word in a packet payload, one skilled in the art will recognize that the above-described method can be configured to detect any combination of letters, symbols, and numbers encoded within a packet's payload. Furthermore, the action specified can include adding, removing, and examining data on a stack such as would be used to parse a context-free grammar. Examples of using a table and a stack to parse a context-free grammar are also described in, for example, A. Aho. et. al., Compilers. Principles, Techniques, and Tools, Addison-Wesley, 1986, which is incorporated herein by reference.

Moreover, in addition to discarding a packet, there are many other network operations that a network device may be called upon to perform on a packet in response to the content of that packet's payload. A lookup table may direct a network device, for example, to redirect the received packet to new destination address or even to alter the content of the packet.

The lookup table 220 may take on various physical forms and still come within the scope of the invention. For example, the lookup table may be implemented in a volatile dynamic random access memory (DRAM) device or non-volatile flash-type memory. Nevertheless it may be advantageous to implement the lookup table in other types of hardware since many network devices such as routers may not have access to these types of general purpose memories. Moreover, these types of memories may not be optimized for search-intensive tasks.

It may be advantageous, for example, to implement the lookup table 220 in a Ternary CAM (TCAM). TCAMs are frequently implemented for search-intensive tasks like lookup functions because they are much faster than algorithmic approaches to search-intensive applications. TCAMs are typically composed of conventional semiconductor memory, usually synchronous random-access memory (SRAM), with added comparison circuitry that enables a search operation to be completed in a single clock cycle. TCAMs, moreover, are easily configured for lookups that use a longest-prefix match algorithm.

Alternatively, the lookup table may be implemented in an algorithmic search engine formed into an application-specific integrated circuit (ASIC) or application-specific standard product (ASSP). These types of specialized integrated circuits will be familiar to one skilled in the art. Like TCAMs, these types of integrated circuits can be configured for lookups that use a longest-prefix match algorithm.

It should again be emphasized that the above-described embodiments of the invention are intended to be illustrative only. Other embodiments can use different types and arrangements of elements and steps for implementing the described functionality. These numerous alternative embodiments will fall within the scope of this invention and will be apparent to one skilled in the art.

What is claimed is:

1. A network device operative to perform a plurality of different network operations on a packet of data in a network, the packet of data having a packet payload comprising one or more encoded characters, the network device comprising:
a lookup table, the lookup table comprising a plurality of table entries; and
packet processing circuitry coupled to the lookup table, the packet processing circuitry being operative to determine which of the plurality of different network operations to perform on the packet of data at least in part by addressing the lookup table with a table input comprising one or more characters from the packet payload, the table entry corresponding to the table input being determined by a longest prefix match algorithm.

2. The network device of claim 1, wherein the lookup table is implemented in a content-addressable memory.

3. The network device of claim 1, wherein the lookup table is implemented in an algorithmic search engine.

4. The network device of claim 1, wherein the lookup table is implemented in at least one of a random access memory and a flash memory.

5. The network device of claim 1, wherein at least one of the plurality of different network operations directs that the packet of data be discarded.

6. The network device of claim 1, wherein at least one of the plurality of different network operations directs that the content of the packet of data be altered.

7. The network device of claim 1, wherein at least one of the plurality of different network operations directs that the packet of data be forwarded to another network device.

8. The network device of claim 1, wherein the packet processing circuitry addresses the lookup table two or more times in determining which of the plurality of different network operations to perform on the packet of data.

9. The network device of claim 1, wherein the network device comprises at least one of a router, a gateway, a bridge, a switch, a hub and a repeater.

10. The network device of claim 1, wherein the packet of data comprises data for an electronic mail message.

11. A method for determining which of a plurality of different network operations to perform on a packet of data in a network, the packet of data having a packet payload comprising one or more encoded characters, the method to be performed by a network device and comprising the step of addressing a lookup table with a table input comprising one or more characters from the packet payload, the lookup table comprising a plurality of table entries and the table entry corresponding to the table input being determined by a longest prefix match algorithm.

12. The method of claim 11, wherein the lookup table is implemented in a content-addressable memory.

13. The method of claim 11, wherein the lookup table is implemented in an algorithmic search engine.

14. The method of claim 11, wherein at least one of the plurality of different network operations directs that the packet of data be discarded.

15. The method of claim 11, wherein the network device comprises at least one of a router, a gateway, a bridge, a switch, a hub and a repeater.

16. A network comprising a plurality of network devices, at least one of the network devices operative to perform a plurality of different network operations on a packet of data in a network, the packet of data having a packet payload comprising one or more encoded characters and the at least one of the network devices comprising:
a lookup table, the lookup table comprising a plurality of table entries; and
packet processing circuitry coupled to the lookup table, the packet processing circuitry being operative to determine which of the plurality of different network operations to perform on the packet of data at least in part by addressing the lookup table with a table input comprising one or more characters from the packet payload, the table entry corresponding to the table input being determined by a longest prefix match algorithm.

17. The network of claim 16, wherein the lookup table is implemented in a content-addressable memory.

18. The network of claim 16, wherein the lookup table is implemented in an algorithmic search engine.

19. The network of claim 16, wherein at least one of the plurality of different network operations directs that the packet of data be discarded.

20. The network of claim 16, wherein the network device comprises at least one of a router, a gateway, a bridge, a switch, a hub and a repeater.
